(19) United States
(12) Patent Application Publication
(10) Pub. No.: US 2026/0148453 A1
(43) Pub. Date: May 28, 2026

(54) IMAGE PROCESSING APPARATUS, IMAGE PROCESSING METHOD, AND PROGRAM

(71) Applicant: FUJIFILM Corporation, Tokyo (JP)

(72) Inventor: Shuhei HORITA, Saitama (JP)

(73) Assignee: FUJIFILM Corporation, Tokyo (JP)

(21) Appl. No.: 19/452,887

(22) Filed: Jan. 20, 2026

Related U.S. Application Data
(63) Continuation of application No. PCT/JP2024/021831, filed on Jun. 17, 2024.

(30) Foreign Application Priority Data
Jul. 28, 2023 (JP) 2023-123726

(51) Int. Cl. G06T 11/60; G06T 7/00

(52) U.S. Cl. CPC G06T 11/60; G06T 7/0002; G06T 2207/20221

(57) ABSTRACT

Provided are an image processing apparatus, an image processing method, and a program that can generate a composite image that is a composite image having relatively less distortion and in which discontinuity in a case of arranging a plurality of composite images is not noticeable. The image processing apparatus acquires an image group including a plurality of images that are acquired by imaging an imaging target object and that have a known arrangement order in a first direction, divides the image group into a plurality of image sets each having one or more first duplicate images included in both image sets adjacent to each other in the first direction, generates a plurality of composite images for each image set by combining the plurality of images included in the image set in the first direction, and removes a part of the first duplicate image for each composite image.

### CROSS-REFERENCE TO RELATED APPLICATIONS

The present application is a Continuation of PCT International Application No. PCT/JP 2024/021831 filed on Jun. 17, 2024 claiming priority under 35 U.S.C § 119(a) to Japanese Patent Application No. 2023-123726 filed on Jul. 28, 2023. Each of the above applications is hereby expressly incorporated by reference, in its entirety, into the present application.

### BACKGROUND OF THE INVENTION

### 1. Field of the Invention

The present invention relates to an image processing apparatus, an image processing method, and a program.

### 2. Description of the Related Art

JP2021-196735A discloses an inspection apparatus that acquires an image for visual inspection of an inspection target object. The apparatus disclosed in JP2021-196735A performs an image combination method of acquiring image data including a plurality of images captured by scanning a surface of an imaging target object, acquiring a first composite image by combining image columns in a short side direction, and acquiring a second composite image by combining a plurality of the first composite images in a longitudinal direction.

JP2019-161635A discloses an image reading apparatus including a first sensor that reads a first region of a document, a second sensor that reads a second region overlapping a part of the first region, a third sensor that reads a third region overlapping a part of the second region, a first processor that generates a first composite image including the first region and the second region, and a second processor that generates a second composite image including the second region and the third region, in which the image reading apparatus performs linking processing of the first composite image and the second composite image to generate an output image.

### SUMMARY OF THE INVENTION

One embodiment according to the technology of the present disclosure provides an image processing apparatus, an image processing method, and a program that can generate a composite image that is a composite image having relatively less distortion and in which discontinuity in a case of arranging a plurality of composite images is not noticeable.

According to a first aspect of the present disclosure, there is provided an image processing apparatus comprising: one or more processors; and one or more memories in which instructions to be executed by the one or more processors are stored, in which the one or more processors are configured to acquire an image group including a plurality of images that are acquired by imaging an imaging target object and that have a known arrangement order in a first direction, divide the image group into a plurality of image sets each having one or more first duplicate images included in both image sets adjacent to each other in the first direction, generate a plurality of composite images for each image set by combining the plurality of images included in the image set in the first direction, and remove a part of the first duplicate image for each composite image.

According to a second aspect, in the image processing apparatus according to the first aspect, the image group may include the plurality of images generated by imaging the imaging target object that extends in the first direction.

According to a third aspect, in the image processing apparatus according to the first or second aspect, the one or more processors may acquire the image group including the plurality of images that have a known arrangement order in a second direction intersecting the first direction, divide the image group into a plurality of image sets each having one or more second duplicate images included in both image sets adjacent to each other in the second direction, generate a plurality of composite images for each image set by combining the plurality of images included in the image set in the second direction, and remove a part of the second duplicate image for composite images adjacent to each other in the second direction.

According to a fourth aspect, in the image processing apparatus according to the third aspect, the image group may include the plurality of images generated by imaging the imaging target object that extends in the first direction and the second direction.

According to a fifth aspect, in the image processing apparatus according to any one of the first to fourth aspects, the one or more processors may detect damage in the imaging target object based on at least any of the image or the composite image, and display, by using a display device, a detection result of the damage on a screen on which the composite image is displayed.

According to a sixth aspect, in the image processing apparatus according to any one of the first to fifth aspects, the one or more processors may display, by using a display device, the plurality of composite images to be arranged along the first direction.

According to a seventh aspect, in the image processing apparatus according to the sixth aspect, the one or more processors may display, by using the display device, a composite image group in which the plurality of composite images are arranged along the first direction to be arranged along a second direction intersecting the first direction.

According to an eighth aspect, in the image processing apparatus according to any one of the first to seventh aspects, the one or more processors may detect damage in the imaging target object based on at least any of the image or the composite image, display, by using a display device, a detection result of the damage on a screen on which the composite image is displayed, and switch, by using the display device, between displaying the composite image or displaying the detection result of the damage.

According to a ninth aspect of the present disclosure, there is provided an image processing method executed by one or more processors provided in a computer, the image processing method comprising: acquiring an image group including a plurality of images that are acquired by imaging an imaging target object and that have a known arrangement order in a first direction; dividing the image group into a plurality of image sets each having one or more first duplicate images included in both image sets adjacent to each other in the first direction; generating a plurality of composite images for each image set by combining the plurality of images included in the image set in the first direction; and removing a part of the first duplicate image for each composite image.

According to a tenth aspect of the present disclosure, there is provided a program causing a computer to execute a process comprising: a function of acquiring an image group including a plurality of images that are acquired by imaging an imaging target object and that have a known arrangement order in a first direction; a function of dividing the image group into a plurality of image sets each having one or more first duplicate images included in both image sets adjacent to each other in the first direction; a function of generating a plurality of composite images for each image set by combining the plurality of images included in the image set in the first direction; and a function of removing a part of the first duplicate image for each composite image.

### BRIEF DESCRIPTION OF THE DRAWINGS

FIG. 1 is a schematic diagram of imaging in a tunnel performed by applying an imaging system according to an embodiment.

FIG. 2 is an explanatory diagram of distortion occurrence occurring at an end of a composite image.

FIG. 3 is a diagram showing a specific example of the composite image in which distortion occurs.

FIG. 4 is a schematic diagram showing an image group having a known arrangement order.

FIG. 5 is a schematic diagram showing image set division.

FIG. 6 is a schematic diagram showing another example of the image set division.

FIG. 7 is an explanatory diagram of image combination.

FIG. 8 is a schematic diagram of end portion removal of the composite image.

FIG. 9 is a schematic diagram of end portion removal of the composite image according to another example.

FIG. 10 is a diagram showing a composite image before the distortion at the end portion is removed.

FIG. 11 is a diagram showing a composite image after the distortion at the end portion is removed.

FIG. 12 is a diagram showing another example of the composite image before the distortion at the end portion is removed.

FIG. 13 is a diagram showing another example of the composite image after the distortion at the end portion is removed.

FIG. 14 is a diagram showing an example of a user interface applied to display of a composite image group.

FIG. 15 is a diagram showing an example of a camera applied to the imaging system according to the embodiment.

FIG. 16 is a schematic diagram showing a traveling state of a camera unit shown in FIG. 15.

FIG. 17 is a functional block diagram showing an example of an electric configuration of the imaging system according to the embodiment.

FIG. 18 is a functional block diagram showing an electric configuration of an image processing apparatus shown in FIG. 17.

FIG. 19 is a block diagram showing a hardware configuration of the image processing apparatus shown in FIG. 18.

FIG. 20 is a flowchart showing a procedure of an image processing method according to the embodiment.

### DESCRIPTION OF THE PREFERRED EMBODIMENTS

Hereinafter, a preferred embodiment of the present invention will be described in detail with reference to the accompanying drawings. In the present specification, the same components are denoted by the same reference numerals, and duplicate description thereof will be omitted as appropriate. In addition, in the following embodiment, in a case where a plurality of components are described and listed, it can be interpreted that at least one of the plurality of components is included.

### Description of Problem

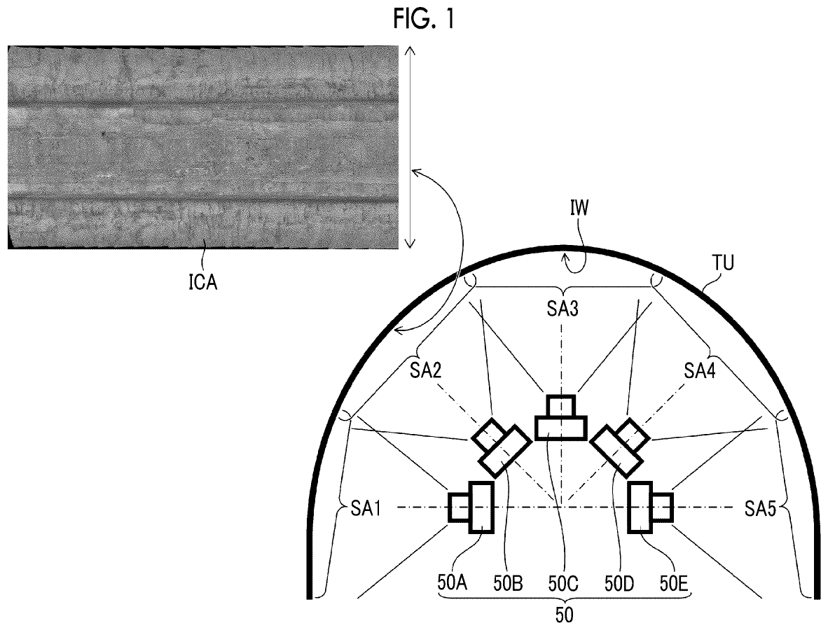

FIG. 1 is a schematic diagram of imaging in a tunnel performed by applying an imaging system according to an embodiment. FIG. 1 schematically shows an imaging system that images an inner wall IW of a tunnel TU by using a camera unit 50 including five cameras 50A, 50B, 50C, 50D, and 50E.

The imaging system images the inner wall IW of the tunnel TU at each of a plurality of imaging positions defined in advance by traveling the camera unit 50 in a longitudinal direction of the tunnel TU in which the tunnel TU extends. The plurality of imaging positions defined in the longitudinal direction of the tunnel TU are defined such that ends of captured images captured at adjacent imaging positions overlap each other. The longitudinal direction of the tunnel TU is a direction penetrating the paper plane of FIG. 1, and is an example of the first direction.

Each of reference numerals SA1, SA2, SA3, SA4, and SA5 shown in FIG. 1 represents an imaging region of each of the camera 50A, the camera 50B, the camera 50C, the camera 50D, and the camera 50E. For example, the imaging regions adjacent to each other in a short side direction of the tunnel TU are defined such that the ends thereof overlap each other. For example, the imaging region SA2 is defined such that a left end in FIG. 1 overlaps an end of the imaging region SA1 and a right end in FIG. 1 overlaps an end of the imaging region SA3. The short side direction of the tunnel TU is a direction orthogonal to the longitudinal direction of the tunnel TU and is a direction along the inner wall IW of the tunnel TU. The longitudinal direction of the tunnel TU according to the embodiment is an example of a second direction.

In addition, FIG. 1 shows a composite image ICA in which a plurality of captured images captured and acquired by using the camera 50B included in the camera unit 50 are combined in the longitudinal direction of the tunnel TU.

It is not realistic to represent an entire long structure such as a tunnel by using one composite image. Therefore, a method has been proposed in which a structure to be represented is divided into a plurality of sections, a composite image is generated for each section, and composite images for each of the plurality of sections are arranged to represent the entire long structure.

However, in a case where the composite image is generated for a long object such as the tunnel, in particular, distortion is likely to occur at an end portion of the composite image due to accumulation of errors and a bias of correspondence points with an adjacent image. The correspondence point here can be referred to as a constraint point or the like. In a case where the plurality of composite images are displayed in an arranged manner and the distortion is present at the end portion of the composite image, discontinuity with the adjacent composite image is noticeable.

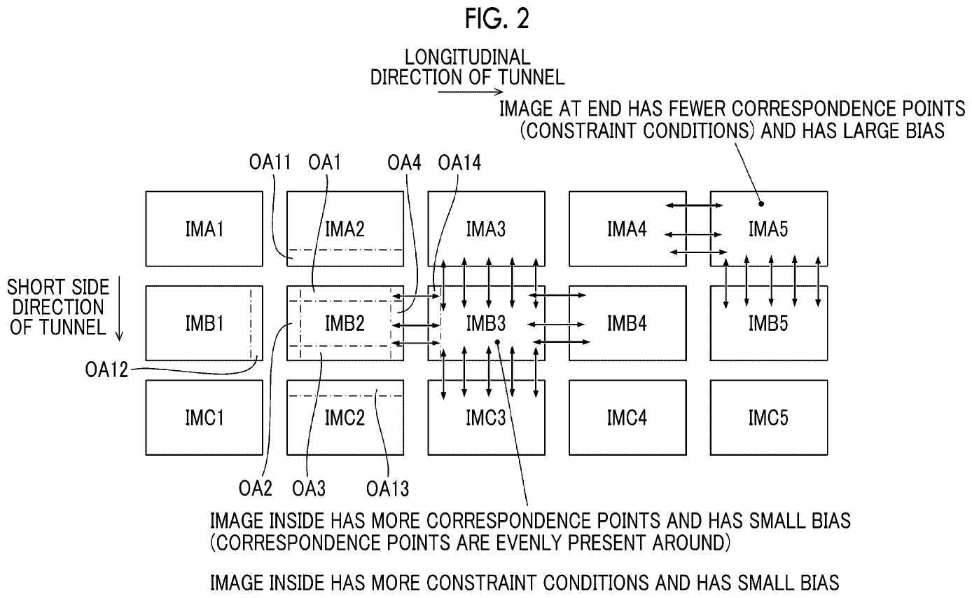

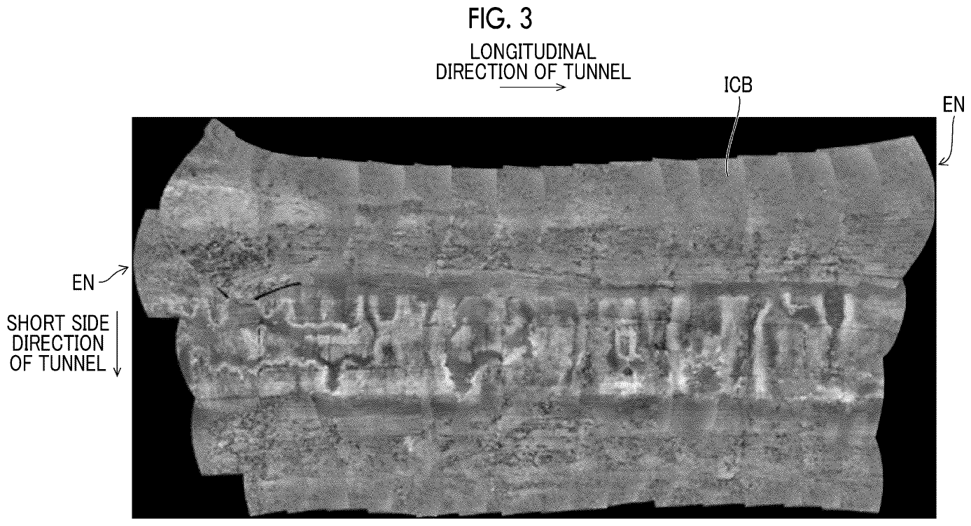

FIG. 2 is an explanatory diagram of distortion occurrence occurring at an end of a composite image. FIG. 3 is a diagram showing a specific example of the composite image in which distortion occurs. A plurality of captured images IMA1 to IMC5 shown in FIG. 2 are components of a composite image ICB shown in FIG. 3.

Each of the plurality of captured images IMA1 to IMC5 shown in FIG. 2 is captured and acquired at each of imaging positions in which five imaging positions along the longitudinal direction of the tunnel and three imaging positions in the short side direction of the tunnel are combined. Each of the captured images IMA1 to IMC5 has an overlapping region that overlaps an adjacent captured image.

For example, a captured image IMB2 has an overlapping region OA1 that overlaps the captured image IMA2 at an end portion on a side of the adjacent captured image IMA2. Similarly, the captured image IMA2 has an overlapping region OA11 having the same area as the overlapping region OA1 at an end on a side of the captured image IMB2.

In addition, the captured image IMB2 has an overlapping region OA2, an overlapping region OA3, and an overlapping region OA4 at an end on each of sides of the captured image IMB1, the captured image IMC2, and the captured image IMB3. The captured image IMB1, the captured image IMC2, and the captured image IMB3 also have an overlapping region OA12, an overlapping region OA13, and an overlapping region OA14 corresponding to the overlapping region OA2, the overlapping region OA3, and the overlapping region OA4, respectively. Hereinafter, the captured images IMA1 and the like will be collectively referred to as a captured image IM in a case where it is not necessary to distinguish between the captured images IMA1 and the like. The captured image IM according to the embodiment is an example of a plurality of images constituting an image group.

Among the plurality of captured images IM shown in FIG. 2, for example, the captured image IMA5 at the end has fewer correspondence points with the adjacent captured image IM than the captured image IMB3 at the center and has a bias. Specifically, the captured image IMA5 has three correspondence points with the captured image IMA4 and has five correspondence points with the captured image IMB5, but does not have the correspondence points on a side opposite to the captured image IMA4 and a side opposite to the captured image IMB5.

A tip of an arrow line connecting the captured image IMA5 and the captured image IMA4 represents the correspondence points between the captured image IMA5 and the captured image IMA4. Similarly, a tip of an arrow line connecting the captured image IMA5 and the captured image IMB5 represents the correspondence points between the captured image IMA5 and the captured image IMB5. The same applies to the arrow line of the captured image IMB3.

On the other hand, the captured image IMB3 at the center and the like, which is the captured image IM not at the end, has more correspondence points than the captured image IM at the end and has correspondence points evenly present around the captured image IM.

The captured image IMA5 at the end, which has fewer correspondence points than the captured image IM not at the end and has a bias of the correspondence points, is significantly affected by distortion caused by a difference between a shape model and an actual imaging target object, such as distortion caused by a calculation error of a transformation relationship for matching the correspondence points and a difference between a cylindrical model and an actual shape of the tunnel, at an end of the composite image ICB shown in FIG. 3. In the composite image ICB shown in FIG. 3, the distortion is significant at both end portions EN in the longitudinal direction.

In addition, in a case where the distortion at the end portion of the composite image is relatively large, a relatively large error may occur in a damage size or the like to be understood based on the composite image, in addition to the problem of the appearance of the composite image described above. The relatively large error in the damage size or the like may be an obstacle in a case of understanding a state of the object based on the captured image of the object.

Therefore, even in a case where the composite image is generated for a long object such as the tunnel, it is preferable that the distortion at the end portion of the composite image is as small as possible. In addition, not only for a long object such as the tunnel but also in a case where the composite image is generated for each of a plurality of regions and the plurality of composite images are arranged to represent an entirety of a huge structure such as a dam, it is preferable that the distortion for each composite image is as small as possible.

### Description of Image Group Having Known Arrangement Order

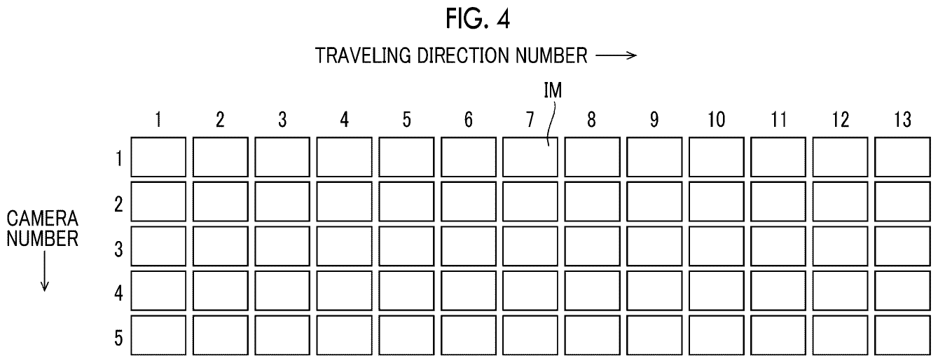

FIG. 4 is a schematic diagram showing an image group having a known arrangement order. The plurality of captured images IM shown in FIG. 4 are defined in the arrangement order by using a camera number and a traveling direction number. In FIG. 4, a reference numeral IM representing the captured image is assigned to any one of the plurality of captured images IM.

Here, the direction in which the traveling direction number is defined is the longitudinal direction of the tunnel shown in FIG. 2 and is a traveling direction in a case where the camera unit 50 shown in FIG. 1 travels. In addition, the direction in which the camera number is defined is the short side direction of the tunnel shown in FIG. 2 and is a direction in which the camera 50A and the like are arranged.

The camera number is a unique number defined for each of the camera 50A, the camera 50B, the camera 50C, the camera 50D, and the camera 50E shown in FIG. 1 according to the arrangement order. For example, the camera 50A may be defined as the camera number 1, the camera 50B may be defined as the camera number 2, the camera 50C may be defined as the camera number 3, the camera 50D may be defined as the camera number 4, and the camera 50E may be defined as the camera number 5.

The traveling direction number is a number representing an imaging position that is assigned in order from an imaging start position to an imaging end position along the traveling direction of the camera 50A and the like. The maximum value of the traveling direction number is defined according to a total length of the imaging target object, an angle of view of the camera 50A and the like, and the like. FIG. 4 shows the captured images IM in which the traveling direction number is 1 to 13, but the captured images IM in which the traveling direction number is 14 or more may also be present. The traveling direction number may be assigned by measuring a position in a case of imaging and based on a measurement result.

The plurality of captured images IM are assigned a unique file name using the camera number and the traveling direction number. That is, a file name that can be discriminated in the arrangement order is assigned to each of the plurality of captured images IM. Examples of the file name include an example in which [camera number]_[traveling direction number].extension is used.

In addition, information representing a correspondence relationship between the file name of each of the plurality of captured images IM and a set of the camera number and the traveling direction number is prepared. Examples of the information representing the correspondence relationship include a correspondence relationship table between a file name such as IMG_0001.extension and the set of the camera number and the traveling direction number. The correspondence relationship table may be applied to a CSV format.

### Image Set Division

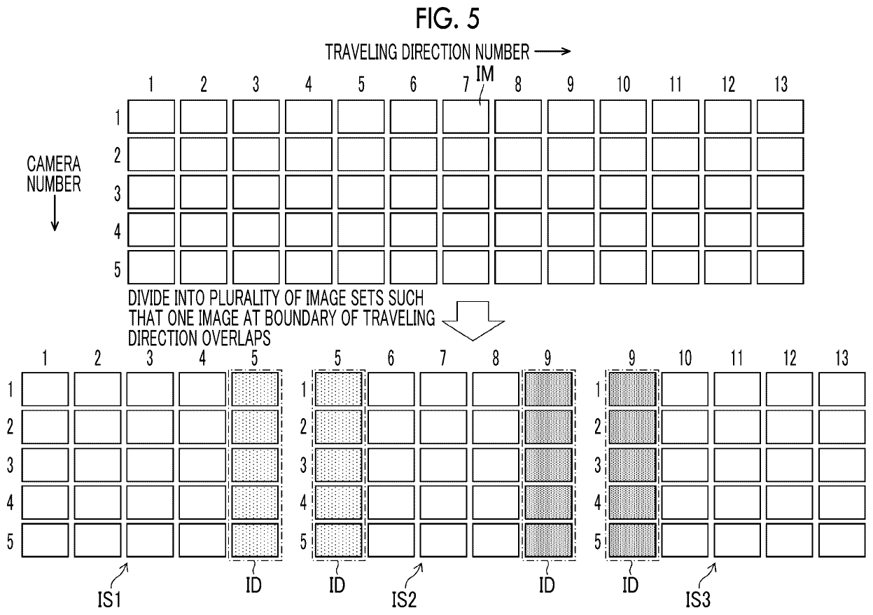

FIG. 5 is a schematic diagram showing image set division. FIG. 5 shows an example of a case where the plurality of captured images IM shown in FIG. 4 are divided into three image sets IS1, IS2, and IS3 in the traveling direction in which the traveling direction number is defined.

One captured image IM overlaps at a boundary between the image set IS1 and the image set IS2 adjacent to each other. In the example shown in FIG. 5, the image set IS1 and the image set IS2 are defined such that the captured image IM in which the traveling direction number is 5 is a duplicate image ID.

Similarly, the image set IS2 and the image set IS3 are defined such that the captured image IM in which the traveling direction number is 9 is the duplicate image ID. The number of image sets IS, the number of captured images IM included in one image set IS, and the number of duplicate images ID included in each image set IS are not limited to the shown example and can be appropriately defined.

For example, in a case where the number of image sets IS is three and the number of duplicate images ID is two, the image sets IS and the duplicate images ID are defined as follows. In the image set IS1, the captured images IM in which the traveling direction numbers are 1 to 5 are applied. In the image set IS2, the captured images IM in which the traveling direction numbers are 4 to 8 are applied. In the image set IS3, the captured images IM in which the traveling direction numbers are 7 to 11 are applied.

In the duplicate image ID at the boundary between the image set IS1 and the image set IS2, the captured image IM in which the traveling direction number is 4 and the captured image IM in which the traveling direction number is 5 are applied. In the duplicate image ID at the boundary between the image set IS2 and the image set IS3, the captured image IM in which the traveling direction number is 7 and the captured image IM in which the traveling direction number is 8 are applied.

In a case where the number of image sets IS is three and the number of duplicate images ID is three, the image sets IS and the duplicate images ID are defined as follows. In the image set IS1, the captured images IM in which the traveling direction numbers are 1 to 7 are applied. In the image set IS2, the captured images IM in which the traveling direction numbers are 5 to 11 are applied. In the image set IS3, the captured images IM in which the traveling direction numbers are 9 to 15 are applied.

In the duplicate image ID at the boundary between the image set IS1 and the image set IS2, the captured images IM in which the traveling direction numbers are 5 to 7 are applied. In the duplicate image ID at the boundary between the image set IS2 and the image set IS3, the captured images IM in which the traveling direction numbers are 9 to 11 are applied.

In a case where the image set IS having the plurality of duplicate images ID is defined in this way, in a case where the distortion is noticeable in the composite image IC generated for each image set IS, there is a large room for removing the distortion, which is preferable.

### Another Example of Image Set Division

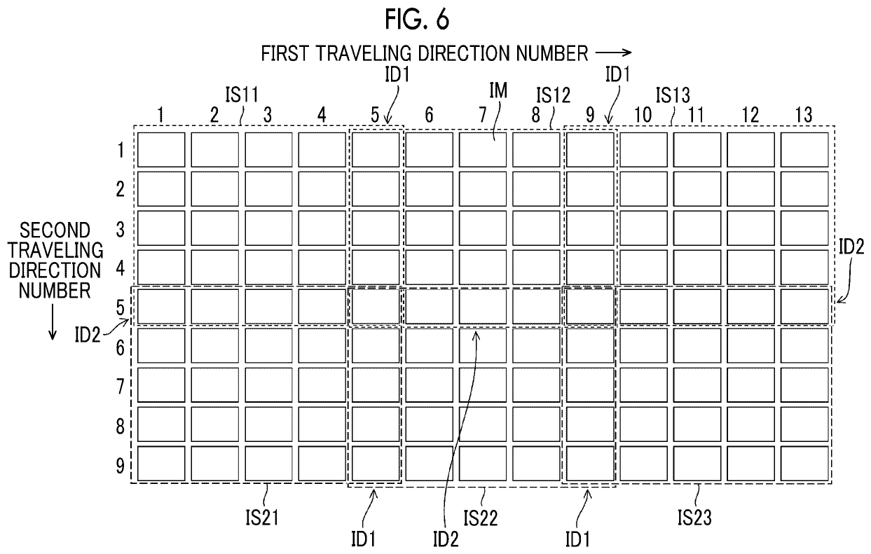

FIG. 6 is a schematic diagram showing another example of the image set division. FIG. 6 shows an example in which the image set division is performed in each of a first traveling direction and a second traveling direction for the plurality of captured images IM in which the arrangement order is defined in the first traveling direction and the second traveling direction orthogonal to each other.

The first traveling direction or the second traveling direction shown in FIG. 6 is an example of the first direction. In addition, a direction different from the first direction among the first traveling direction and the second traveling direction is an example of the second direction. The second traveling direction orthogonal to the first traveling direction shown in FIG. 6 or the first traveling direction orthogonal to the second traveling direction is an example of the second direction intersecting the first direction.

The image set division shown in FIG. 6 is applied in a case where the imaging target object is scanned with the camera in the first traveling direction and the second traveling direction, imaging is performed at a plurality of imaging positions, and a plurality of captured images IM are acquired. Examples of the imaging target object include a structure that needs to move the camera in a two-dimensional manner in a case of imaging the entire structure such as a dam.

FIG. 6 shows an example in which the plurality of captured images IM having a known arrangement order in each of the first traveling direction and the second traveling direction are divided into six image sets IS11, IS12, IS13, IS21, IS22, and IS23, and one duplicate image ID1 or ID2 is defined at a boundary of adjacent image sets IS.

The number of duplicate images ID1 and the number of duplicate images ID2 may be two or more. The number of duplicate images ID1 in the first traveling direction and the number of duplicate images ID2 in the second traveling direction may be the same or different from each other.

### Image Combination

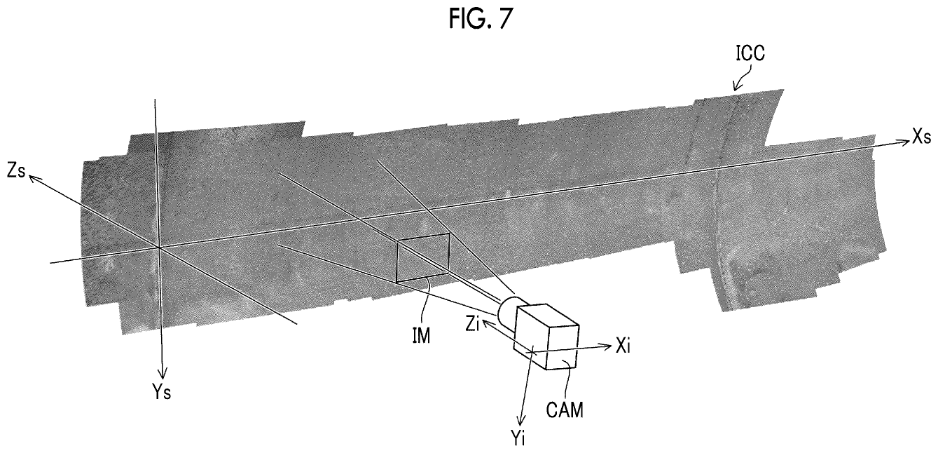

FIG. 7 is an explanatory diagram of image combination. In the image combination, a composite parameter is determined from a result of the correspondence point matching between the adjacent captured images IM, and one composite image is generated for the plurality of captured images IM included in the image set IS. Further, the composite images for each image set IS are combined to generate a composite image group corresponding to the entire measurement target object. Each image set IS according to the embodiment is an example for each image set.

The composite parameter includes a posture parameter of the shape model, a posture parameter for each camera for each of the plurality of captured images IM, and a lens distortion parameter for each camera for each of the plurality of captured images IM.

The posture parameter of the shape model in a case where the shape model is a planar model includes a rotation matrix and a translation vector. The posture parameter of the shape model in a case where the shape model is a cylindrical model includes a rotation matrix, a translation vector, and a radius of the cylinder. The composite parameter in a case where the planar model is applied may be a projective transformation matrix of each captured image IM.

A non-rigid transformation including enlargement and reduction may be applied as the posture parameter. Examples of the non-rigid transformation include an affine transformation.

The captured image IM is projected onto the shape model based on the determined composite parameter, and the composite image ICC is generated. In a case where the shape model is the cylindrical model, the planar development is further performed.

FIG. 7 shows a three-dimensional coordinate system having an Xs axis, a Ys axis, and a Zs axis orthogonal to each other as a coordinate system applied to the posture parameter of the shape model. In addition, FIG. 7 shows a three-dimensional coordinate system having an Xi axis, a Yi axis, and a Zi axis orthogonal to each other as a coordinate system applied to the posture parameter for each camera CAM and the lens distortion parameter for each camera CAM. i is a continuous number starting from 1 representing the imaging position. The Xs axis and the Xi axis shown in FIG. 7 correspond to the longitudinal direction of the tunnel shown in FIG. 2. The Ys axis and the Yi axis shown in FIG. 7 correspond to the short side direction of the tunnel shown in FIG. 2.

In the image combination, a part of the plurality of captured images IM included in the image set IS may be combined and optimized repeatedly to combine all of the plurality of captured images IM included in the image set IS.

The composite image IC may be generated by combining the plurality of captured images IM for each of the camera 50A and the like in the Xs direction to generate a composite image element, and combining the composite image elements for each of the camera 50A and the like in the Ys direction.

### End Portion Removal of Composite Image

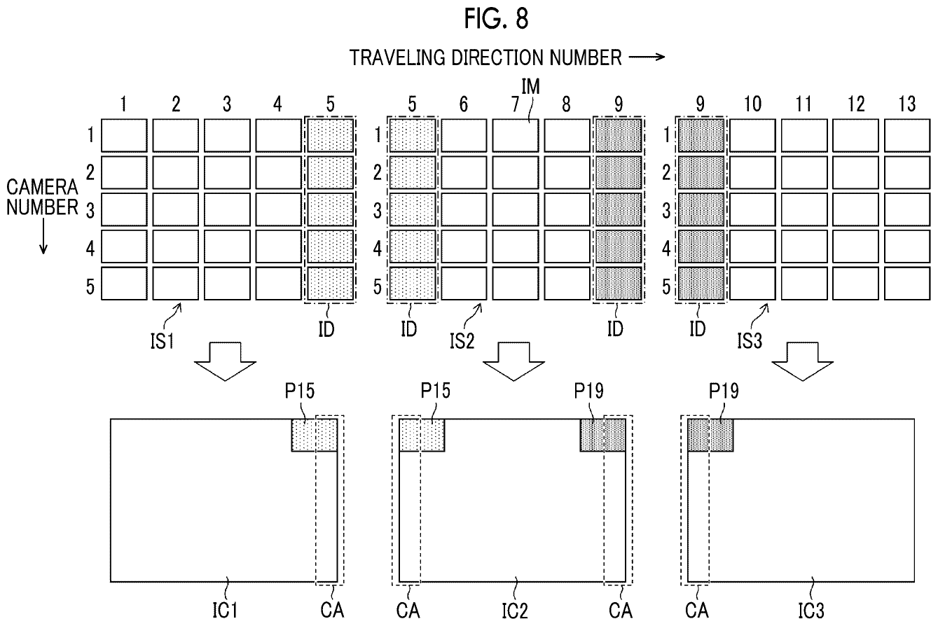

FIG. 8 is a schematic diagram of end portion removal of the composite image. FIG. 8 schematically shows a correspondence relationship between the image set IS1 and the composite image IC1, a correspondence relationship between the image set IS2 and the composite image IC2, and a correspondence relationship between the image set IS3 and the composite image IC3. The image set IS1, the image set IS2, and the image set IS3 shown in the upper part of FIG. 8 are the same as the image set IS1, the image set IS2, and the image set IS3 shown in the lower part of FIG. 5.

The plurality of captured images IM included in the image set IS1 are combined to generate the composite image IC1. In addition, the plurality of captured images IM included in the image set IS2 are combined to generate the composite image IC2, and the plurality of captured images IM included in the image set IS3 are combined to generate the composite image IC3.

Although the distortion occurs in each of the actual composite image IC1, the composite image IC2, and the composite image IC3, in FIG. 8, each of the composite image IC1, the composite image IC2, and the composite image IC3 is represented as a rectangular shape.

A part of a region of the image set IS corresponding to the duplicate image ID is removed from each of the end portions of the composite image IC1, the composite image IC2, and the composite image IC3. A removal region CA to be removed from the composite image IC1 and the like is schematically shown by using a broken line. FIG. 8 shows an example in which half of the region corresponding to the duplicate image ID is removed for each of the composite image IC1, the composite image IC2, and the composite image IC3. The removal region CA may be more than 0% and less than 50% of the region corresponding to the duplicate image ID, or may be more than 50% and less than 100% of the region corresponding to the duplicate image ID.

In the composite image IC1 and the composite image IC2, a position P15 corresponding to the captured image IM in which the camera number is 1 and the traveling direction number is 5 is shown. In addition, in the composite image IC2 and the composite image IC3, a position P19 corresponding to the captured image IM in which the camera number is 1 and the traveling direction number is 9 is shown.

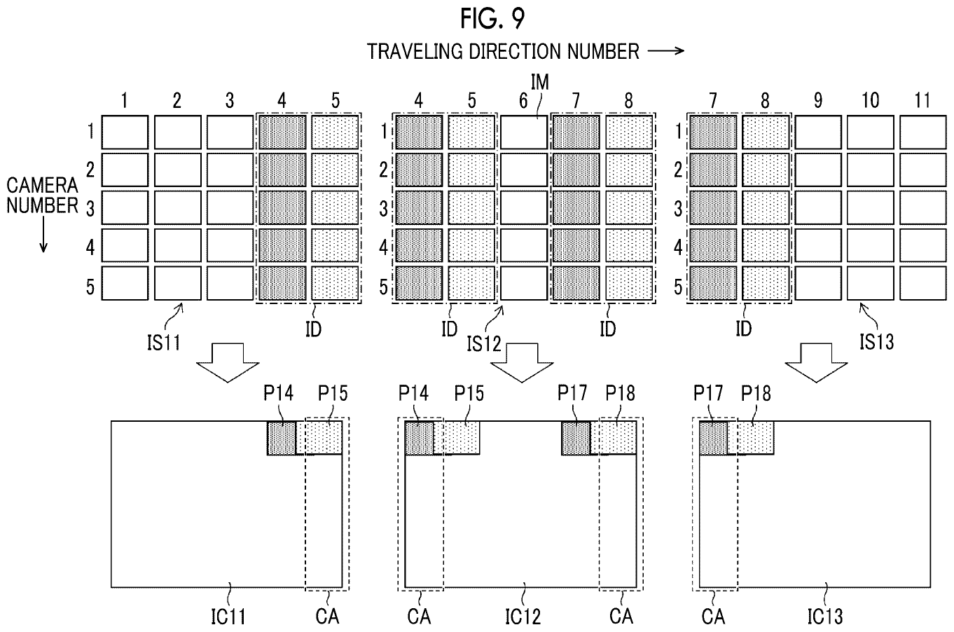

FIG. 9 is a schematic diagram of end portion removal of the composite image according to another example. FIG. 9 shows an aspect in which the end portion removal is performed for a composite image IC11, a composite image IC12, and a composite image IC13 in a case where the number of duplicate images ID set in each of an image set IS11, an image set IS12, and an image set IS13 is 2.

In the image set IS11 shown in FIG. 9, the captured image IM in which the traveling direction number is 4 and the captured image IM in which the traveling direction number is 5 are defined as the duplicate image ID. In the image set IS12, the captured image IM in which the traveling direction number is 4 and the captured image IM in which the traveling direction number is 5 are defined as the duplicate image ID, and the captured image IM in which the traveling direction number is 7 and the captured image IM in which the traveling direction number is 8 are defined as the duplicate image ID. In the image set IS13, the captured image IM in which the traveling direction number is 7 and the captured image IM in which the traveling direction number is 8 are defined as the duplicate image ID.

The composite image IC11 is generated by combining the plurality of captured images IM included in the image set IS11. Similarly, the composite image IC12 is generated by combining the plurality of captured images IM included in the image set IS12, and the composite image IC13 is generated by combining the plurality of captured images IM included in the image set IS13.

In the composite image IC11, the removal region CA that is a part of the duplicate image ID of the image set IS11 is removed. Specifically, in the composite image IC11, a part of the position P14, which corresponds to the captured image IM in which the traveling direction number is 4, and a part of the position P15, which corresponds to the captured image IM in which the traveling direction number is 5, are removed as the removal region CA.

In the composite image IC12, the removal region CA that is a part of the duplicate image ID of the image set IS12 is removed, and the removal region CA that is a part of the duplicate image ID of the image set IS12 is removed.

Specifically, in the composite image IC12, a part of the position P14, which corresponds to the captured image IM in which the traveling direction number is 4, and a part of the position P15, which corresponds to the captured image IM in which the traveling direction number is 5, are removed as the removal region CA. In addition, in the composite image IC12, a part of the position P17, which corresponds to the captured image IM in which the traveling direction number is 7, and a part of the position P18, which corresponds to the captured image IM in which the traveling direction number is 8, are removed as the removal region CA.

In the composite image IC13, the removal region CA that is a part of the duplicate image ID of the image set IS13 is removed. Specifically, in the composite image IC13, a part of the position P17, which corresponds to the captured image IM in which the traveling direction number is 7, and a part of the position P18, which corresponds to the captured image IM in which the traveling direction number is 8, are removed as the removal region CA.

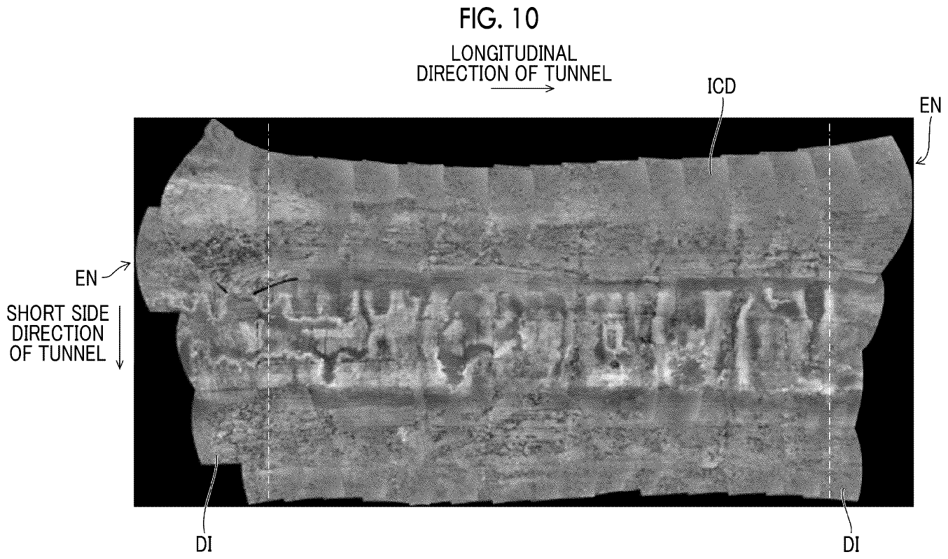

FIG. 10 is a diagram showing a composite image before the distortion at the end portion is removed. In the composite image ICD shown in FIG. 10, as in the composite image ICB shown in FIG. 3, a distortion DI occurs at both the one end portion EN and the other end portion EN in the longitudinal direction of the tunnel.

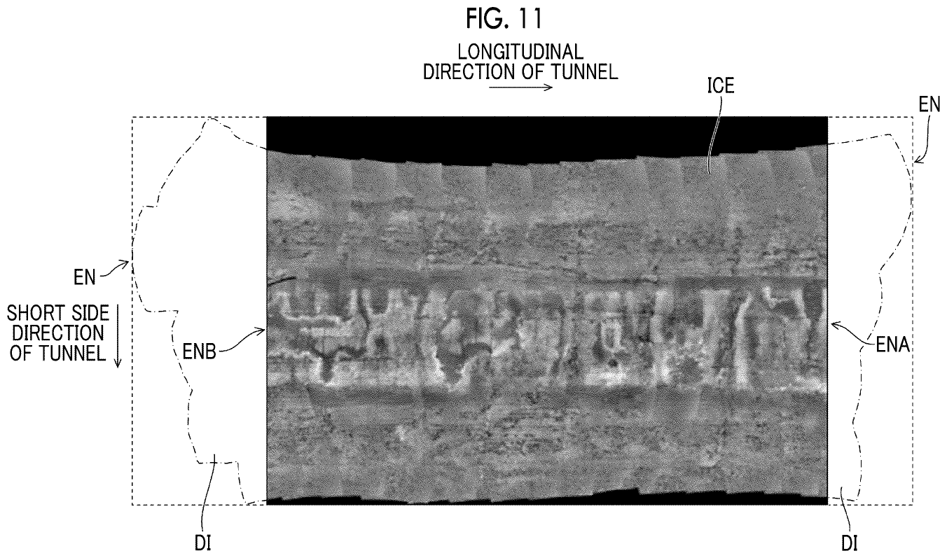

FIG. 11 is a diagram showing a composite image after the distortion at the end portion is removed. In the composite image ICE shown in FIG. 11, the distortion DI of the one end portion EN and the other end portion EN in the composite image ICD shown in FIG. 10 is removed. One end ENA and the other end ENB of the composite image ICE shown in FIG. 11 are linear sides parallel to the short side direction of the tunnel.

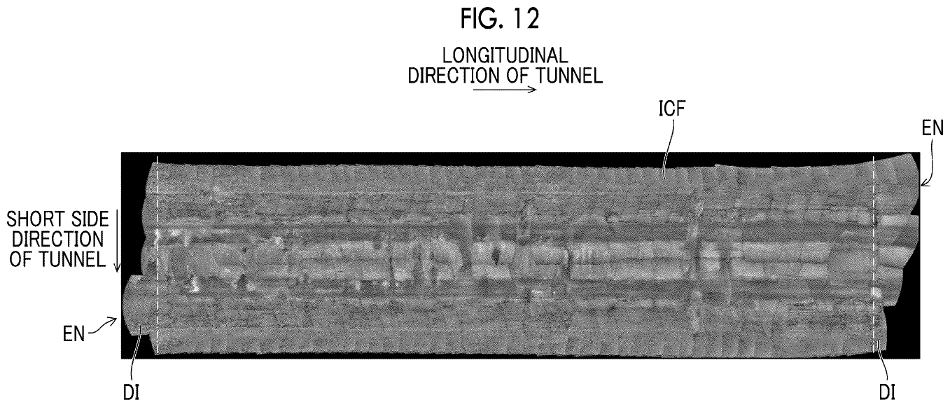

FIG. 12 is a diagram showing another example of the composite image before the distortion at the end portion is removed. FIG. 12 shows a case where the number of captured images IM constituting the composite image ICF is larger than the number of captured images IM constituting the composite image ICD shown in FIG. 10.

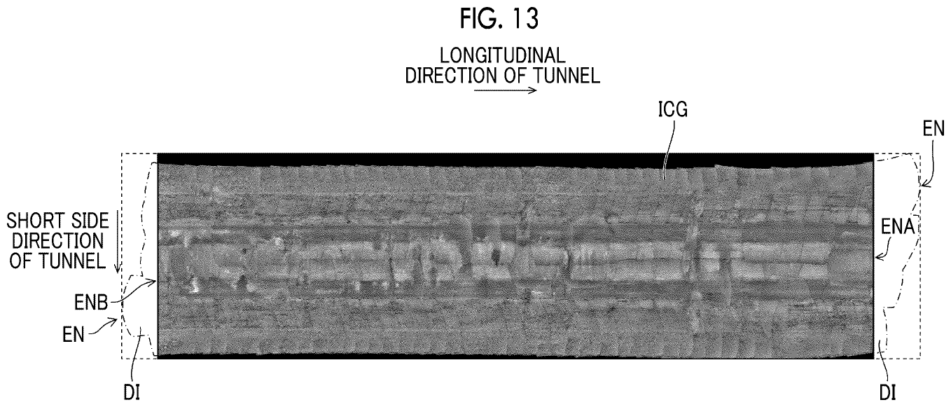

FIG. 13 is a diagram showing another example of the composite image after the distortion at the end portion is removed. In the composite image ICG shown in FIG. 13, as in the composite image ICE shown in FIG. 12, the distortion DI of the one end portion EN and the other end portion EN in the composite image ICF shown in FIG. 12 is removed. One end ENA and the other end ENB of the composite image ICG shown in FIG. 13 are linear sides parallel to the short side direction of the tunnel.

The composite image ICE in which the distortion DI of the end portion EN shown in FIG. 11 is trimmed and the composite image ICG in which the distortion DI of the end portion EN shown in FIG. 13 is trimmed are generated in a plurality of pieces corresponding to the total length of the tunnel that is the imaging target object.

A process of combining the plurality of composite images ICE and the like is applied to a process applied to the captured image IM in the generation of the composite image ICD shown in FIG. 10 and the like, such as a process of matching the correspondence points of the adjacent composite images.

### User Interface Applied to Display of Composite Image Group

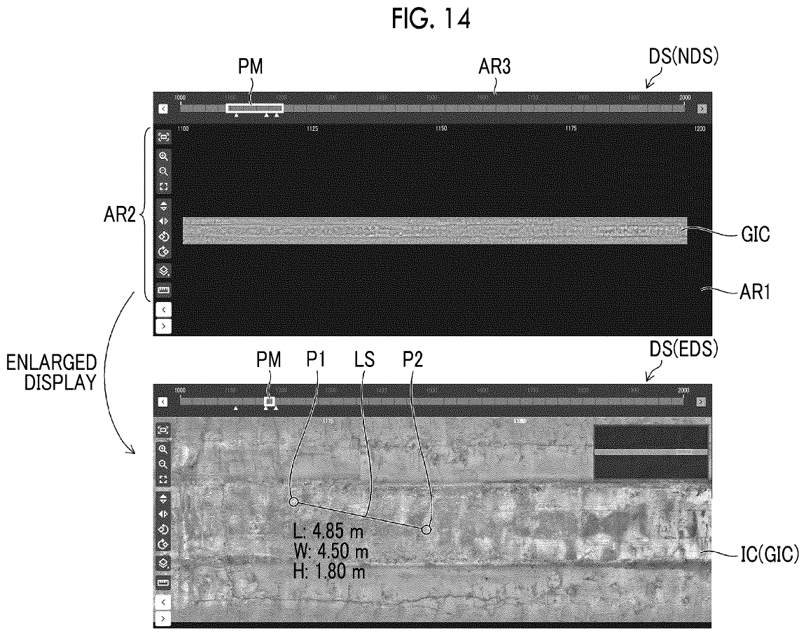

FIG. 14 is a diagram showing an example of a user interface applied to display of a composite image group. FIG. 14 shows an example of a display screen DS on which a plurality of composite images IC are arranged and displayed as a composite image group GIC. In the composite image group GIC shown in FIG. 14, in a case where the positions of the duplicate images ID of the adjacent composite images IC in the plurality of composite images IC are aligned and the adjacent composite images IC have a region that overlaps, the overlapping regions are overlapped. On the other hand, in a case where the adjacent composite images IC do not have a region that overlaps, the adjacent composite images IC are arranged without being overlapped.

The display screen DS is configured to be freely switched between a normal display screen NDS and an enlarged display screen EDS. The switching between the normal display screen NDS and the enlarged display screen EDS is performed based on an instruction from the user.

FIG. 14 shows an example in which, in the normal display screen NDS, for example, ten composite images IC corresponding to 10 meters in the longitudinal direction of the tunnel are arranged in the longitudinal direction of the tunnel, among the imaging target tunnels having a total length of several kilometers. That is, 100 meters of a part of the longitudinal direction of the tunnel having a total length of several kilometers is displayed on the normal display screen NDS.

In the enlarged display screen EDS shown in FIG. 14, one composite image IC included in the ten composite images IC displayed on the normal display screen NDS is displayed. The enlarged display screen EDS shown in FIG. 14 is superimposed and displayed at the upper right corner of the enlarged display screen EDS by reducing the normal display screen NDS.

The display screen DS includes a first region AR1, a second region AR2, and a third region AR3. In the first region AR1, the composite image group GIC is displayed on the normal display screen NDS, and a part of the composite image group GIC displayed on the normal display screen NDS, such as one composite image IC, is enlarged and displayed on the enlarged display screen EDS.

In the second region AR2, a toolbar including an icon representing various tools is displayed. Examples of the various tools include enlargement and reduction. In the third region AR3, a position bar is displayed. The entire composite image group GIC is reduced and displayed on the position bar. The position bar includes a mark PM representing a range of the composite image group GIC displayed in the first region AR1 in the entire composite image group GIC. FIG. 14 shows an example in which a rectangular figure is applied as the mark PM.

The position bar displayed on the normal display screen NDS includes the mark PM representing a region of ten composite images IC. In addition, the position bar displayed on the enlarged display screen EDS includes the mark PM representing a region of one composite image IC.

In a case where the plurality of captured images IM are divided into the plurality of image sets IS and the composite image is generated for each of the plurality of image sets IS for the first traveling direction and the second traveling direction shown in FIG. 6, the plurality of composite images IC for each image set IS are arranged for the first traveling direction, and the plurality of composite images IC for each image set IS are arranged for the second traveling direction.

In a case where the plurality of composite images IC are arranged for the first traveling direction, the positions of the duplicate images ID of the first traveling direction are aligned, and the plurality of composite images IC are arranged to overlap the duplicate image ID1. Similarly, in a case where the plurality of composite images IC are arranged for the second traveling direction, the positions of the duplicate images ID2 of the second traveling direction are aligned, and the plurality of composite images IC are arranged to overlap the duplicate image ID2. The duplicate image ID1 of the first traveling direction according to the embodiment is an example of the first duplicate image, and the duplicate image ID2 of the second traveling direction according to the embodiment is an example of the second duplicate image.

In a case where any two points on the composite image IC are designated on the enlarged display screen EDS, a length of the designated two points is measured, and the measurement result is displayed. For example, in the composite image IC of the enlarged display screen EDS shown in FIG. 14, in a case where the points P1 and P2 are designated, the designated points P1 and P2 are displayed, and a line segment LS connecting the point P1 and the point P2 is displayed.

In addition, on the enlarged display screen EDS, measurement values of a length L of the line segment LS, a width W of the line segment LS, and a height H of the line segment LS are displayed as the measurement results of the points P1 and P2. The width W of the line segment LS is a component of the length of the line segment LS in the longitudinal direction of the tunnel, and the height H of the line segment LS is a component of the length of the line segment LS in the short side direction of the tunnel.

FIG. 14 shows an aspect in which the measurement results of the points P1 and P2 are superimposed and displayed on the composite image IC, but the measurement results of the points P1 and P2 may be displayed in a region different from the first region AR1, the second region AR2, and the third region AR3.

The measurement of any two points designated on the composite image IC can be applied to the measurement of the damage of the imaging target object. For example, in a case where the imaging target object is the inner wall IW of the tunnel TU, both end positions of the damage such as a scratch, a chip, a breakage, and a discoloration on the inner wall IW of the tunnel TU can be designated, and the size of the damage can be measured. The calculation for any two points designated on the composite image IC may be performed by using the captured image IM constituting the composite image IC.

The switching between the normal display screen NDS described with reference to FIG. 14 and the enlarged display screen EDS on which the measurement results of any two points on the composite image IC are displayed is an example of switching between displaying the composite image and displaying the detection result of the damage. In addition, the designation of the point P1 and the point P2 shown in FIG. 14 is an example of the damage detection in the measurement target object, and the measurement results of the point P1 and the point P2 are examples of the detection result of the damage.

As described above, the image processing apparatus may manually detect the damage on the inner wall IW of the tunnel TU from the composite image IC, but may automatically detect the damage on the inner wall IW of the tunnel TU from the captured image IM or the composite image IC. The image processing apparatus may display the damage on the inner wall IW of the tunnel TU.

The image processing apparatus may switch between superimposing and displaying the result of the damage detection on the inner wall IW of the tunnel TU on the composite image IC or displaying the composite image IC without displaying the result of the damage detection on the inner wall IW of the tunnel TU.

### Configuration Example of Imaging System According to Embodiment

### Configuration Example of Camera Unit

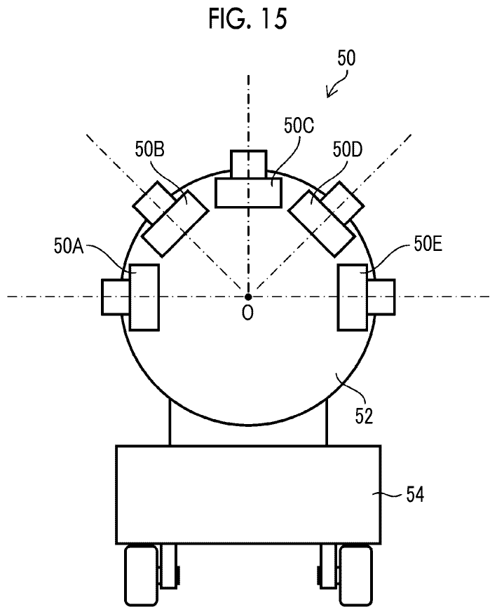

FIG. 15 is a diagram showing an example of a camera applied to the imaging system according to the embodiment. The camera unit 50 comprises the camera 50A, the camera 50B, the camera 50C, the camera 50D, and the camera 50E. The camera 50A, the camera 50B, the camera 50C, the camera 50D, and the camera 50E are disposed in an arc shape at an equal distance from a reference position O of a camera support base 52. The camera support base 52 is attached to a carriage 54.

Optical axes of the camera 50A, the camera 50B, the camera 50C, the camera 50D, and the camera 50E are radially disposed from the reference position O of the camera support base 52. Imaging directions of the camera 50A and the like are different from each other, and the camera 50A and the like simultaneously image the inner wall IW of the tunnel TU shown in FIG. 1.

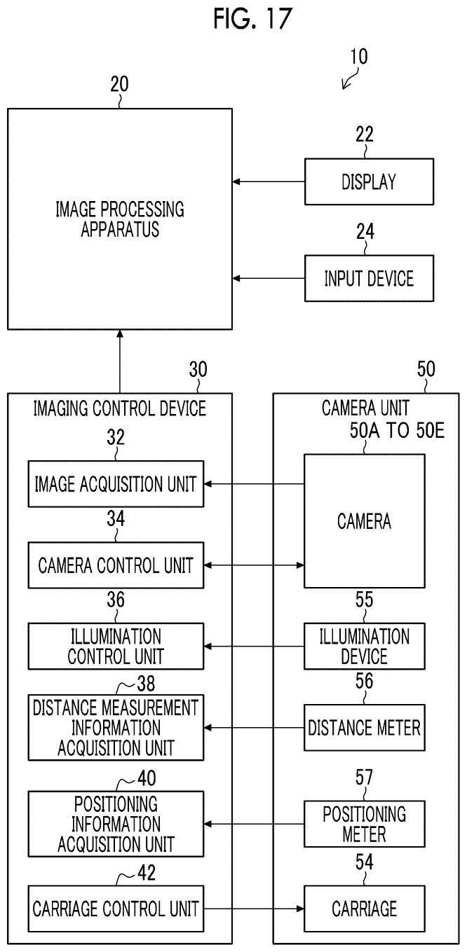

The camera support base 52 comprises an illumination device, a distance meter, and a positioning meter. In FIG. 15, the illumination device, the distance meter, and the positioning meter are not shown. The illumination device, the distance meter, and the positioning meter are respectively denoted by reference numerals 55, 56, and 57 and are shown in FIG. 17. The illumination device emits illumination light to the imaging region of the camera 50A and the like. The illumination device may be individually provided for each of the camera 50A and the like.

The distance meter measures a distance from a position of the distance meter to the inner wall IW of the tunnel TU. A laser distance meter in which laser light is used is applied as the distance meter. Examples of the laser distance meter include LiDAR. LiDAR is an abbreviation for light detection and ranging. The laser distance meter causes laser light emitted from a measurement head to revolve, emits the laser light to the inner wall IW of the tunnel TU, and measures a distance between the measurement head and the inner wall IW of the tunnel TU.

It is preferable that the distance meter converts the measured distance into a distance in the same direction as the optical axis of the camera 50A and the like based on an angle between the optical axis of the camera 50A and the like and the laser light. The distance meter may emit the laser light in the same direction as the optical axis of the camera 50A and the like without causing the laser light to revolve.

The positioning meter outputs a positioning signal representing a position of the carriage 54 in the traveling direction. The longitudinal direction of the tunnel shown in FIG. 2 is applied to the traveling direction of the carriage 54. That is, the positioning meter measures a traveling distance from a traveling start position of the carriage 54 and generates the positioning signal representing the position of the carriage 54 in the traveling direction based on the measurement result.

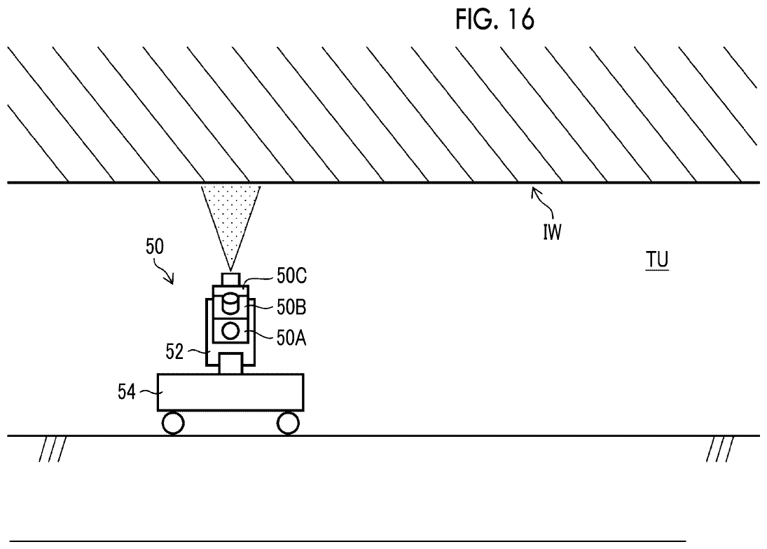

FIG. 16 is a schematic diagram showing a traveling state of the camera unit shown in FIG. 15. FIG. 16 schematically shows a state in which the inner wall IW of the tunnel TU is imaged by using the camera 50A and the like while the camera unit 50 travels along the traveling direction. The camera unit 50 stops at an imaging position along the traveling direction, which is an imaging position defined in advance, and images the inner wall IW of the tunnel TU.

### Electric Configuration of Imaging System

FIG. 17 is a functional block diagram showing an example of an electric configuration of the imaging system according to the embodiment. The imaging system 10 comprises an image processing apparatus 20, an imaging control device 30, and the camera unit 50. The camera unit 50 images the inner wall IW of the tunnel TU by using the camera 50A and the like and generates the captured image.

The imaging control device 30 is a control device that controls the camera unit 50, operates the camera unit 50, images the inner wall IW of the tunnel TU by using the camera 50A and the like, and generates the captured image. The imaging control device 30 transmits the captured image to the image processing apparatus 20. A computer is applied to the imaging control device 30.

The image processing apparatus 20 generates a plurality of composite images IC by using the captured image IM of the inner wall IW of the tunnel TU transmitted from the imaging control device 30. The image processing apparatus 20 displays the composite image group GIC in which the plurality of composite images IC are arranged by using a display 22.

The image processing apparatus 20 measures the inner wall IW of the tunnel TU by using the composite image IC. An example in which a distance between two points on the inner wall IW of the tunnel TU is measured is shown in FIG. 14. In a case where a signal for defining positions of two points transmitted from the input device 24 is acquired, the image processing apparatus 20 measures the distance between the two points.

The imaging control device 30 comprises an image acquisition unit 32. The image acquisition unit 32 acquires an electric signal representing the captured image IM transmitted from the camera 50A and the like. The captured image IM acquired by using the image acquisition unit 32 is transmitted to the image processing apparatus 20.

The imaging control device 30 comprises a camera control unit 34. The camera control unit 34 controls the operation of each of the camera 50A and the like in a case of imaging the inner wall IW of the tunnel TU. The camera control unit 34 transmits an imaging signal representing an imaging start to the camera 50A and the like at a defined imaging timing. Each of the camera 50A and the like images the inner wall IW of the tunnel TU based on the imaging signal.

The camera control unit 34 transmits information on a distance from each of the camera 50A and the like to the inner wall IW of the tunnel TU, which is measured by using the distance meter 56, to each of the camera 50A and the like. The camera 50A and the like can perform focusing based on the distance to the inner wall IW of the tunnel TU.

The camera control unit 34 sets an imaging condition for each of the camera 50A and the like. For example, the camera control unit 34 sets an imaging resolution as the imaging condition for each of the camera 50A and the like.

The imaging control device 30 comprises an illumination control unit 36. The illumination control unit 36 sets an illumination condition applied to the illumination device 55 and controls an operation of the illumination device 55 based on the illumination condition. Examples of the illumination condition include an irradiation intensity of the illumination light.

The imaging control device 30 comprises a distance measurement information acquisition unit 38. The distance measurement information acquisition unit 38 acquires distance measurement information representing the distance from each of the camera 50A and the like to the inner wall IW of the tunnel TU, which is transmitted from the distance meter 56. The camera control unit 34 transmits the distance measurement information acquired by using the distance measurement information acquisition unit 38 to each of the camera 50A and the like.

The imaging control device 30 comprises a positioning information acquisition unit 40. The positioning information acquisition unit 40 acquires positioning information representing a position of the camera unit 50 in the traveling direction of the camera unit 50, which is transmitted from the positioning meter 57. The camera control unit 34 images the inner wall IW of the tunnel TU at a defined measurement position by using the camera 50A and the like based on the positioning information acquired by using the positioning information acquisition unit 40.

The imaging control device 30 comprises a carriage control unit 42. The carriage control unit 42 sets a traveling condition of the carriage 54 and performs traveling control of the carriage 54 based on the traveling condition of the carriage 54. The traveling condition of the carriage 54 includes a traveling speed and a stop timing of the carriage 54.

### Configuration Example of Image Processing Apparatus

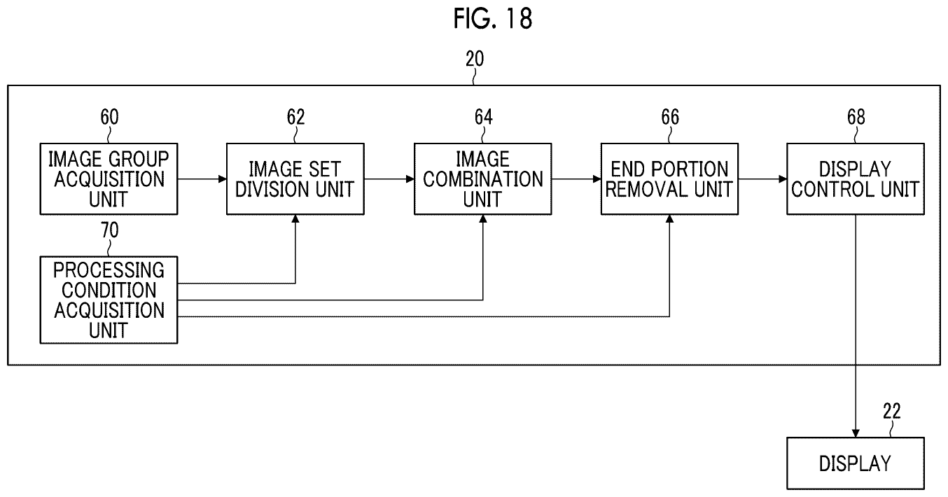

FIG. 18 is a functional block diagram showing an example of an electric configuration of the image processing apparatus shown in FIG. 17. The image processing apparatus 20 comprises an image group acquisition unit 60. The image group acquisition unit 60 acquires a plurality of captured images that are acquired by measuring the inner wall IW of the tunnel TU and that have a known arrangement order. The captured images having a known arrangement order are shown in FIG. 4 as the plurality of captured images IM in which the arrangement order is defined by using the traveling direction number and the camera number.

The image processing apparatus 20 comprises an image set division unit 62. The image set division unit 62 divides the plurality of captured images having a known arrangement order, which are acquired by using the image group acquisition unit 60, into the plurality of image sets IS shown in FIG. 5. The image set IS1 shown in FIG. 5 and the like is collectively referred to as the image set IS.

The image processing apparatus 20 comprises an image combination unit 64. The image combination unit 64 performs a combination process of combining the plurality of captured images IM included in each of the plurality of image sets IS for each image set IS defined by using the image set division unit 62 to generate the composite image IC. An example of the composite image IC is shown in FIG. 10 as the composite image ICD.

The image processing apparatus 20 comprises an end portion removal unit 66. The end portion removal unit 66 removes the distortion DI of the end portion EN of the composite image IC for each image set IS. An example of the composite image IC in which the distortion DI of the end portion EN is removed is shown in FIG. 11 as the composite image ICE.

The image processing apparatus 20 comprises a display control unit 68. The display control unit 68 generates a display signal representing the composite image group GIC in which the plurality of composite images IC are arranged, and transmits the generated display signal to the display 22 shown in FIG. 17. The composite image group GIC is displayed on the display 22. An example of the display of the composite image group GIC is shown in FIG. 14.

The display control unit 68 generates a display signal representing a part of the composite image group GIC for enlarged display, and transmits the generated display signal to the display 22. A part of the composite image group GIC is enlarged and displayed on the display 22. An example of the enlarged display of the part of the composite image group GIC is shown in FIG. 14. The display 22 shown in FIG. 18 is an example of a display device.

The image processing apparatus 20 comprises a processing condition acquisition unit 70. The processing condition acquisition unit 70 acquires a processing condition applied to various processes. The processing condition acquisition unit 70 sets a processing condition such as the number of image sets, the number of captured images IM included in the image set, and the number of duplicate images in the image set division process performed by using the image set division unit 62.

The processing condition acquisition unit 70 sets a processing condition applied to the generation of the composite image IC for each image set IS performed by using the image combination unit 64. The processing condition acquisition unit 70 sets a processing condition of an end portion removal process of removing the distortion DI for each composite image IC performed by using the end portion removal unit 66. The processing condition acquisition unit 70 sets a processing condition of a generation process of the composite image group GIC performed by using a composite image group generation unit 67.

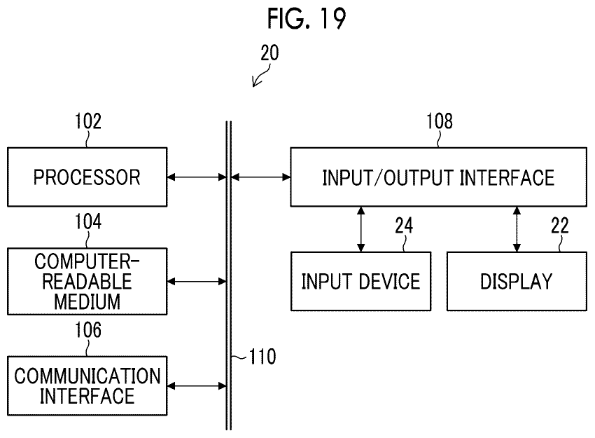

FIG. 19 is a block diagram showing a hardware configuration of the image processing apparatus shown in FIG. 18. As the image processing apparatus 20, a computer is applied. The computer may be a personal computer or a workstation. The computer may be a virtual machine.

The image processing apparatus 20 comprises a processor 102, a computer-readable medium 104, a communication interface 106, an input/output interface 108, and a bus 110. The processor 102 is connected to the computer-readable medium 104, the communication interface 106, and the input/output interface 108 via the bus 110. The display 22 and the input device 24 are connected to the image processing apparatus 20 via the input/output interface 108.

The image processing apparatus 20 comprises one or more processors 102 and one or more memories. The processor 102 of the image processing apparatus 20 executes various programs stored in the memory of the computer-readable medium 104 to implement various functions of the image processing apparatus 20.

The processor 102 includes a CPU. The processor 102 may include a GPU. The processor 102 is connected to the computer-readable medium 104, the communication interface 106, and the input/output interface 108 via the bus 110. In addition, CPU is an abbreviation for central processing unit, and GPU is an abbreviation for graphics processing unit.

The computer-readable medium 104 may include a memory that is a main memory and a storage device that is an auxiliary memory. A semiconductor memory, a hard disk apparatus, a solid state drive apparatus, and the like can be applied to the computer-readable medium 104. Any combination of a plurality of devices can be applied to the computer-readable medium 104.

The hard disk apparatus can be referred to as an HDD which is an abbreviation for hard disk drive in English. The solid state drive apparatus can be referred to as an SSD which is an abbreviation for solid state drive in English.

The various programs stored in the memory of the computer-readable medium 104 include one or more instructions. Various types of data, various parameters, and the like are stored in the computer-readable medium 104. The term “program” is synonymous with the term “software”.

A hardware structure of the processor 102 is various processors as described below. The various processors include a CPU that is a general-purpose processor that executes software to act as various functional units, a GPU that is a processor specialized for image processing, a programmable logic device (PLD) such as a field programmable gate array (FPGA) that is a processor of which a circuit configuration can be changed after manufacture, and a dedicated electric circuit such as an application specific integrated circuit (ASIC) that is a processor having a circuit configuration dedicatedly designed to execute specific processing.

The hardware configuration of the image processing apparatus shown in FIG. 19 can also be applied to the computer that functions as the imaging control device 30 shown in FIG. 17.

### Procedure of Image Processing Method According to Embodiment

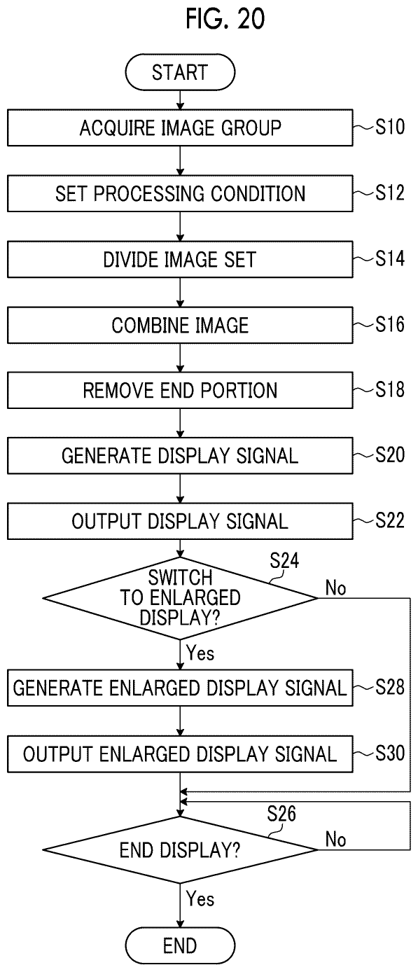

FIG. 20 is a flowchart showing a procedure of an image processing method according to the embodiment. In an image group acquisition step S10, the image group acquisition unit 60 shown in FIG. 18 acquires the plurality of captured images IM having a known arrangement order. After the image group acquisition step S10, the process proceeds to a processing condition setting step S12.

In the processing condition setting step S12, various processing conditions applied to an image set division step S14, an image combination step S16, and an end portion removal step S18 are set. After the processing condition setting step S12, the process proceeds to the image set division step S14.

In the image set division step S14, the image set division unit 62 divides the plurality of captured images IM having a known arrangement order, which are acquired by using the image group acquisition unit 60, into the plurality of image sets IS. After the image set division step S14, the process proceeds to the image combination step S16.

In the image combination step S16, the image combination unit 64 generates the composite image IC for each of the plurality of image sets IS defined in the image set division step S14. After the image set division step S14, the process proceeds to the end portion removal step S18.

In the end portion removal step S18, the end portion removal unit 66 removes the distortion DI of the end portion EN for each of the plurality of composite images IC. After the end portion removal step S18, the process proceeds to a display signal generation step S20.

In the display signal generation step S20, the display control unit 68 generates a display signal of the composite image group GIC in which the plurality of composite images IC are arranged. After the display signal generation step S20, the process proceeds to a display signal output step S22. In the display signal output step S22, the display control unit 68 outputs the display signal of the composite image group GIC to the display 22. The composite image group GIC is displayed on the display 22.

During the display of the composite image group GIC on the display 22, an enlarged display determination step S24 is executed. In the enlarged display determination step S24, the display control unit 68 determines whether or not to acquire a signal representing switching to the enlarged display.

In the enlarged display determination step S24, in a case where the display control unit 68 does not acquire the signal representing the switching to the enlarged display, a No determination is made. In a case of the No determination, the process proceeds to an end determination step S26.

In the end determination step S26, the image processing apparatus 20 determines whether or not to end the image processing. In the end determination step S26, in a case where the image processing apparatus 20 determines to continue the image processing, a No determination is made. In a case of the No determination, the process proceeds to the image group acquisition step S10, and each step from the image group acquisition step S10 to the end determination step S26 is repeatedly executed until a Yes determination is made in the end determination step S26.

On the other hand, in the end determination step S26, in a case where the image processing apparatus 20 determines to end the image processing, a Yes determination is made. In a case of the Yes determination, a defined end process is performed, and the procedure of the image processing method ends.

In the enlarged display determination step S24, in a case where the display control unit 68 acquires the signal representing the switching to the enlarged display, a Yes determination is made. In a case of the Yes determination, the process proceeds to an enlarged display signal generation step S28.

In the enlarged display signal generation step S28, the display control unit 68 generates an enlarged display signal for enlarging a part of the composite image group GIC. For example, in the enlarged display signal generation step S28, an enlarged display signal representing the enlarged display screen EDS shown in FIG. 14 is generated. After the enlarged display signal generation step S28, the process proceeds to an enlargement display signal output step S30.

In the enlargement display signal output step S30, the display control unit 68 outputs the enlarged display signal generated in the enlarged display signal generation step S28 to the display 22. For example, the enlarged display screen EDS is displayed on the display 22. After the enlargement display signal output step S30, the process proceeds to the end determination step S26.

In a case where the enlarged display is performed, a measurement step of measuring the measurement target object may be executed. In the measurement step, a measurement point designation step of designating a measurement point, a calculation step of performing a calculation based on the designated measurement point to derive a measurement result, and a measurement result display step of displaying a measurement result can be included.

### Operation and Effect of Embodiment

The image processing apparatus, the image processing method, and the imaging system according to the embodiment can obtain the following operation and effect.
[1]

An image group including a plurality of captured images IM having a known arrangement order in a traveling direction in which the imaging target object is imaged is acquired. The plurality of captured images IM are image sets including the plurality of captured images IM, and are divided into a plurality of image sets each having one or more duplicate images ID included in both image sets adjacent to each other in the traveling direction. The plurality of captured images IM included in each of the plurality of image sets are combined in the traveling direction to generate the composite image IC. The distortion DI of the end portion EN of the composite image IC is removed for each composite image IC.

As a result, in a case where the plurality of composite images IC are arranged along the traveling direction as the composite image group, discontinuity of the composite image group due to the occurrence of the distortion DI of the end portion EN for each composite image IC in the traveling direction is not noticeable.
[2]

The plurality of captured images IM having a known arrangement order in a direction in which the imaging target object is imaged can be generated by causing the camera to travel along a direction in which the imaging target object extends and imaging the imaging target object by using the camera at a plurality of imaging positions.
[3]

An image group including a plurality of captured images IM having a known arrangement order in a camera direction orthogonal to a direction in which the imaging target object is imaged is acquired. The plurality of captured images IM are image sets including the plurality of captured images IM, and are divided into a plurality of image sets each having one or more duplicate images ID included in both image sets adjacent to each other in the camera direction. The plurality of captured images IM included in each of the plurality of image sets are combined in the camera direction to generate the composite image IC. The distortion DI of the end portion EN of the composite image IC is removed for each composite image IC.

As a result, in a case where the plurality of composite images IC are arranged along the camera direction as the composite image group, discontinuity of the composite image group due to the occurrence of the distortion DI of the end portion EN for each composite image IC in the camera direction is not noticeable.
[4]

The image group including a plurality of captured images IM having a known arrangement order in the camera direction can be generated by imaging the imaging target object in the camera direction by using a plurality of cameras arranged along the camera direction.
[5]

The image group including a plurality of captured images IM having a known arrangement order in the camera direction can be generated by causing the camera to travel along the camera direction and imaging the imaging target object by using the camera at a plurality of imaging positions along the camera direction.
[6]

The composite image group GIC in which the plurality of composite images IC are arranged along the traveling direction and the composite image group GIC in which the plurality of composite images IC are arranged along the camera direction are displayed on the display 22. As a result, an imaging result of the measurement target object is visualized.
[7]

In the enlarged display screen EDS, any two points on the composite image IC are designated, and the measurement of the designated two points is performed. As a result, in the measurement of the damage performed by designating two points included in the damage of the measurement target object, a measurement result in which the influence of the distortion DI of the end portion EN of the composite image IC is reduced can be obtained.
[8]

In the enlarged display screen EDS, the measurement result of the designated two points is displayed. As a result, the measurement result is visualized.

In the above-described embodiment of the present invention, the configuration requirements can be appropriately changed, added, or deleted without departing from the gist of the present invention. The present invention is not limited to the above-described embodiment, and various modifications can be made by a person having ordinary knowledge in the field within the technical idea of the present invention. In addition, the embodiment, the modification example, and the application example may be appropriately combined and performed.

### EXPLANATION OF REFERENCES

10: Imaging System
20: image processing apparatus
22: display
24: input device
30: imaging control device
32: image acquisition unit
34: camera control unit
36: illumination control unit
38: distance measurement information acquisition unit
40: positioning information acquisition unit
42: carriage control unit
50: camera unit
50A: camera
50B: camera
50C: camera
50D: camera
50E: camera
52: camera support base
54: carriage
55: illumination device
56: distance meter
57: positioning meter
60: image group acquisition unit
62: image set division unit
64: image combination unit
66: end portion removal unit
68: display control unit
70: processing condition acquisition unit
102: processor
104: computer-readable medium
106: communication interface
108: input/output interface
110: bus
AR1: first region
AR2: second region
AR3: third region
CA: removal region
CAM: camera
DI: distortion
DS: display screen
EDS: enlarged display screen
EN: end portion
ENA: one end
ENB: other end
GIC: composite image group
IC1: composite image
IC2: composite image
IC3: composite image
IC11: composite image
IC12: composite image
IC13: composite image
ICA: composite image
ICB: composite image
ICC: composite image
ICD: composite image
ICE: composite image
ICF: composite image
ICG: composite image
ID: duplicate image
ID1: duplicate image
ID2: duplicate image
IM: captured image
IMA1: captured image
IMA2: captured image
IMA3: captured image
IMA4: captured image
IMA5: captured image
IMB1: captured image
IMB2: captured image
IMB3: captured image
IMB4: captured image
IMB5: captured image
IMC1: captured image
IMC2: captured image
IMC3: captured image
IMC4: captured image
IMC5: captured image
IS1: image set
IS2: image set
IS3: image set
IS11: image set
IS12: image set
IS13: image set
IS21: image set
IS22: image set
IS23: image set
IW: inner wall
LS: line segment
NDS: normal display screen
O: reference position
OA1: overlapping region
OA2: overlapping region
OA3: overlapping region
OA4: overlapping region
OA11: overlapping region
OA12: overlapping region
OA13: overlapping region
OA14: overlapping region
P1: point
P2: point
P14: position
P15: position
P17: position
P18: position
P19: position
PM: mark
S10 to S30: each step of image processing method

What is claimed is:

1. An image processing apparatus comprising:
one or more processors; and
one or more memories in which instructions to be executed by the one or more processors are stored,
wherein the one or more processors are configured to:
acquire an image group including a plurality of images that are acquired by imaging an imaging target object and that have a known arrangement order in a first direction;
divide the image group into a plurality of image sets each having one or more first duplicate images included in both image sets adjacent to each other in the first direction;
generate a plurality of composite images for each image set by combining the plurality of images included in the image set in the first direction; and
remove a part of the first duplicate image for each composite image.

2. The image processing apparatus according to claim 1,
wherein the image group includes the plurality of images generated by imaging the imaging target object that extends in the first direction.

3. The image processing apparatus according to claim 1,
wherein the one or more processors are configured to:
acquire the image group including the plurality of images that have a known arrangement order in a second direction intersecting the first direction;
divide the image group into a plurality of image sets each having one or more second duplicate images included in both image sets adjacent to each other in the second direction;
generate a plurality of composite images for each image set by combining the plurality of images included in the image set in the second direction; and
remove a part of the second duplicate image for composite images adjacent to each other in the second direction.

4. The image processing apparatus according to claim 3,
wherein the image group includes the plurality of images generated by imaging the imaging target object that extends in the first direction and the second direction.

5. The image processing apparatus according to claim 1,
wherein the one or more processors are configured to:
detect damage in the imaging target object based on at least any of the image or the composite image; and
display, by using a display device, a detection result of the damage on a screen on which the composite image is displayed.

6. The image processing apparatus according to claim 1,
wherein the one or more processors are configured to:
display, by using a display device, the plurality of composite images to be arranged along the first direction.

7. The image processing apparatus according to claim 6,
wherein the one or more processors are configured to:
display, by using the display device, a composite image group in which the plurality of composite images are arranged along the first direction to be arranged along a second direction intersecting the first direction.

8. The image processing apparatus according to claim 1,
wherein the one or more processors are configured to:
detect damage in the imaging target object based on at least any of the image or the composite image;
display, by using a display device, a detection result of the damage on a screen on which the composite image is displayed; and
switch, by using the display device, between displaying the composite image or displaying the detection result of the damage.

9. An image processing method executed by one or more processors provided in a computer, the image processing method comprising:
acquiring an image group including a plurality of images that are acquired by imaging an imaging target object and that have a known arrangement order in a first direction;
dividing the image group into a plurality of image sets each having one or more first duplicate images included in both image sets adjacent to each other in the first direction;
generating a plurality of composite images for each image set by combining the plurality of images included in the image set in the first direction; and
removing a part of the first duplicate image for each composite image.

10. A non-transitory, computer-readable tangible recording medium on which a program is recorded, the program causing a computer to execute a process comprising:
a function of acquiring an image group including a plurality of images that are acquired by imaging an imaging target object and that have a known arrangement order in a first direction;
a function of dividing the image group into a plurality of image sets each having one or more first duplicate images included in both image sets adjacent to each other in the first direction;
a function of generating a plurality of composite images for each image set by combining the plurality of images included in the image set in the first direction; and
a function of removing a part of the first duplicate image for each composite image.
